(19) United States
(12) Patent Application Publication
(10) Pub. No.: US 2013/0340271 A1
(43) Pub. Date: Dec. 26, 2013

(54) DEVICE FOR MEASURING STRAIGHTNESS AND SQUARENESS OF WALLS, FLOOR, AND CEILING OF BUILDING STRUCTURES AND THE LIKE

(71) Applicant: John Valher, Seaford (AU)

(72) Inventor: John Valher, Seaford (AU)

(21) Appl. No.: 13/745,733

(22) Filed: Jan. 18, 2013

(30) Foreign Application Priority Data
Jun. 6, 2012 (AU) 2012203425

(51) Int. Cl. G01B 5/25

(52) U.S. Cl. CPC G01B 5/25
USPC 33/404

(57) ABSTRACT

A device for measuring ‘square’ of a building structure having walls, floors, and ceilings. The device includes a substantially longitudinal planar body having a mounting portion for receiving a handle member. The handle member is adapted to be adjustably mounted on or adjacent the mounting portion of the body to allow selective positioning of the handle member relative to the body. The mounting portion of the body includes a releasable locking means which locates the handle member substantially perpendicular to the body in an operating condition for performing square measurements of floors, walls, and ceilings of the building structure or the like. In a released condition, the locking means allows the handle member to fold against the body. The device can further include a marker device mounted on a portion of the longitudinal body with a trigger mechanism which initiates release of marking fluid when the device indicates off-square.

### FIELD OF THE INVENTION

The present invention relates to a device for measuring straightness and ‘square’ of a building or like structure including floors, ceilings, and walls. In particular, the present invention is directed to a device which can be conveniently used to measure straightness and squareness of internal walls, floors, and ceilings of a building structure or the like.

### BACKGROUND

In the building and housing construction industry, it is commonplace to measure floors, ceilings, and walls to ensure that the walls, floors, and ceilings are substantially square, or detect alignment issues for remedial work. This is usually performed on a daily basis so that a construction problem can be identified and corrected before it is repeated.

While certain tolerances are allowed in construction of a house, for example, deviation of walls, floors, and ceilings beyond allowable tolerances can cause serious structural and/or aesthetic issues. In some instances, such structural or aesthetic issues, if detected in time, can be rectified at the builder's expense. If, however, issues arising from defective work cannot be rectified, which result from aspects of the quality of building work, disputes may occur requiring the intervention of a third party.

In a recent investigation by the Victorian Building Commission of disputes and their causes arising from building contracts, it has been found that in 3.6 percent of projects, there were serious issues resulting in disputes requiring arbitration. While it is accepted as a general practice to measure the ‘squareness’ of a building structure, it is clear that in some cases, this practice is not strictly adhered to because generally used methods are impractical and time consuming.

One of the ways to determine if a building is square, that is, each corner is a perfect right angle, is to measure the distance of the diagonals. If these measurements are equal, the building is square. For small buildings, this measurement is easily made. For larger buildings, the sag of a measuring tape can be a factor in the accuracy of the measurements. This type of measurement requires skill and tools not normally part of the do-it-yourselfer's set. A further drawback of this accepted method is that trades-people may need to constantly climb ladders in order to make measurements of walls and ceilings.

One method of measuring ‘squareness’ includes measuring precisely three feet from one corner along the width of the foundation in a straight line, marking a spot three feet from the starting point with a stick, then measuring the distance between the two sticks. It should be precisely five feet if the foundation is squared. If it is more or less than five feet, the two lines for the width and length are not at a 90-degree angle to each other and must be corrected for a square foundation. While this represents a conventional method, this has a number of drawbacks, not the least of which is that it is time consuming and in some instances an operator has to climb a ladder, adding to the time and the possibility of injury or stress to an already injured person.

It is known to perform a leveling operation by using a length of flexible tube with a transparent pipe at each end, the tube being filled with a liquid so that the levels at two positions can be checked simply by holding the pipes vertically at the two site positions, when the surface level in each tube can be readily inspected. This type of equipment, however, has a number of limitations and practical disadvantages. For example, it cannot readily be used to check the level of a floor at different points, and unless the two ends of the apparatus can be inspected simultaneously, it is subject to considerable error. The tube also needs to be filled and refilled repeatedly.

Thus, there remains a need for a means for measuring ‘square’ of a building structure that addresses one or more of the drawbacks of the prior art.

### SUMMARY

In the present disclosure, there is provided a device for measuring ‘square’ of a building structure having walls, floors, and ceilings. The device includes a substantially longitudinal planar body having a mounting portion for receiving a handle member, and a handle member wherein the handle member is adapted to be adjustably mounted on or adjacent the mounting portion of the body to allow selective positioning of the handle member relative to the body. The mounting portion of the body includes a releasable locking means which locates the handle member substantially perpendicular to the body in an operating condition for performing square measurements of floors, walls, and ceilings of the building structure or the like, and in a released condition the locking means allows the handle member to fold against the body.

The device disclosed herein allows ready measurement of the square of a building structure very quickly without the need for measuring tape and marking surfaces and re-measuring. The device can be readily used to measure floors, walls, and ceilings by an operator substantially without needing to bend for floors or climb ladders for ceilings. This represents a substantial departure from the prior art measuring devices.

According to a preferred feature, the longitudinal body and/or the handle can include one or more level indicators oriented to allow visible determination of square. The longitudinal body can also include height indicators.

The mounting portion of the longitudinal body can include a cut-out portion adapted to receive a portion of the handle member therein in an operating condition. The handle member can be pivotally mounted on the body at or close to the cut-out portion of the mounting portion so that a portion of the handle member moves in and out of the cut-out portion between an operating and folded condition. The handle member can include a slide shaft for receiving a pivot mount on a portion of the body adjacent the mounting portion, wherein the pivot mount can slidably move within the slide shaft as the handle member moves between a folded condition and an operating condition. The handle member can also include an extension means.

The releasable locking means can include interlocking components in the mounting portion and the handle member, the interlocking components being releasably interlocking for maintaining the position of the handle substantially perpendicular to the longitudinal body.

The releasable locking means can include a locking pin in the mounting portion biased to a locking position so that when the handle member is moved to an operating condition from a folded condition, the pin locks the handle member to the mounting portion in a substantially perpendicular orientation to the longitudinal body.

In a related aspect, there is disclosed a device for measuring squareness of floors, walls, and ceilings of a building or like structure including a first elongate member having generally rectangular or square cross-section having a level indicator; a second member adjustably mounted to the first elongate member wherein the second member is adjustably movable relative to the first elongate member between a storage and operating condition; and a releasable locking means which operates to locate and hold the second member substantially perpendicular relative to the elongate member in an operating condition. In an operating condition, the second member guides the first member into a position to measure a predetermined distance and level of a surface, whereby the second member can readily reposition the first member along a surface substantially without an operator kneeling, bending, or requiring a climbing device.

In a further embodiment of the present invention, the square measuring device can include a marker device adapted to be mounted on a portion of the longitudinal body of the squareness measuring device. The marker device can include a support pole mountable to the longitudinal body, a mounting structure on the longitudinal body for receiving a canister of a marking fluid, wherein the mounting structure further includes a trigger mechanism which initiates release of marking fluid from the canister when the indicators on the square measuring device indicates off-square.

In the normal coarse of measuring square of a floor, walls, and ceilings of a building structure, the trigger device is actuated by an operator by pulling on the cord when the square measuring device identifies areas of a surface which are not square. Alternatively, the trigger device can be linked directly to the indicators to automatically activate egress of marking fluid from the canister when the indicators of the square measuring device depart from square.

In a related aspect, there is further contemplated a square measuring device formed of a planar member including a first longitudinal member and a second longitudinal member attached to one end of the first member and extending perpendicular thereto, wherein one or both of the first and second members includes a mounting portion thereon. The square measuring device includes a handle means adapted for mounting in the mounting portion, whereby the handle means projects upwardly from the mounting means in a mounting condition substantially at right angles so that the handle can be used by an operator to direct the planar member over a surface to measure squareness of the surface.

### DESCRIPTION OF THE DRAWINGS

The foregoing aspects and many of the attendant advantages of this invention will become more readily appreciated as the same become better understood by reference to the following detailed description, when taken in conjunction with the accompanying drawings. The invention may be performed in various ways and one specific embodiment will now be described by way of example with reference to the accompanying drawings, in which:

FIG. 1 is a schematic representation in partial side view of a device according to the present invention;

FIG. 2 is a schematic view of the device in FIG. 1 shown in an operating condition;

FIG. 3 is a photographic view of one embodiment of the present invention showing the handle in an operating condition;

FIG. 4 is a photograph illustrating the device in use as a square measuring device; and

FIG. 5 is a photograph of a trigger device for use in association with the present invention to mark a defective surface.

### DETAILED DESCRIPTION

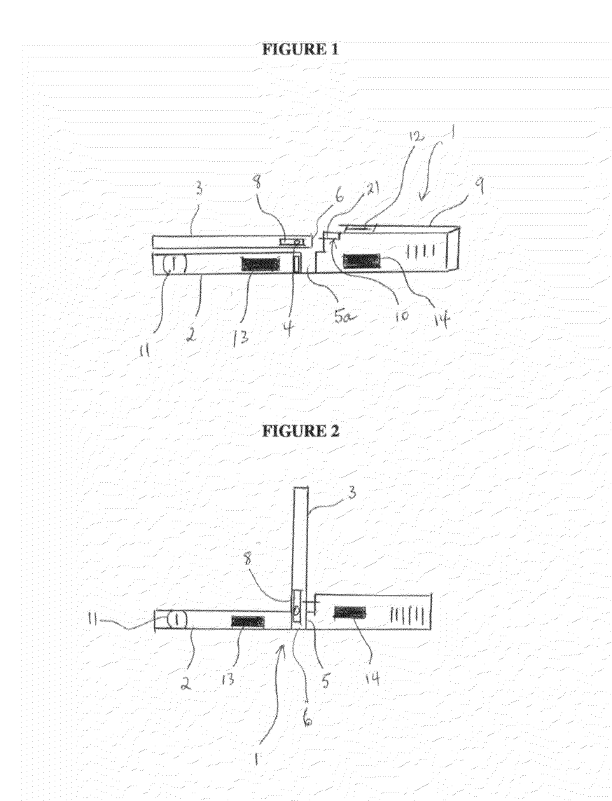

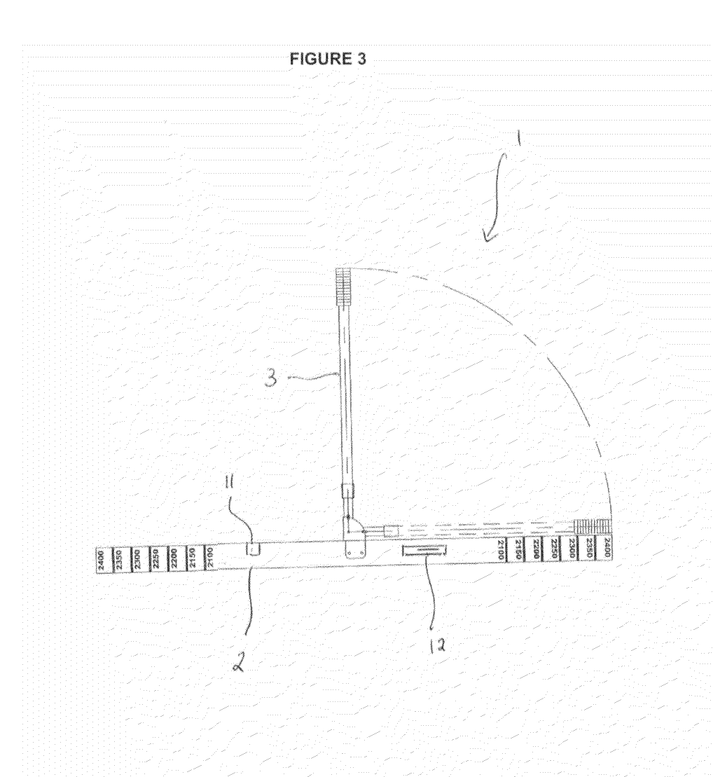

Referring to FIGS. 1 to 3 of these drawings, there is shown a device 1 for measuring ‘squareness’ of floors, walls, and ceilings of a building structure or the like (not shown). The device 1 includes a longitudinal body 2 and a handle 3 pivotally mounted to a portion of the longitudinal body 2 by a pivot mount 4 for movement between a folded condition (see FIG. 1) and an operating condition (see FIGS. 2 and 3).

As best shown in FIGS. 1 and 2, the device 1 includes a mounting portion 5 located centrally of the longitudinal body 1. The mounting portion 5 comprises a vertically disposed cut-out section 5a for receiving a base portion 6 of the handle 3 in an operating condition (best seen in FIG. 2). The cut-out portion 5a is configured to accommodate a base portion of the handle in a substantially perpendicular orientation relative to the longitudinal body. In FIGS. 1 and 2, the base portion 6 of the handle includes a slide shaft 8 which cooperates with a pivot mount 4 to allow pivoting and linear movement of the handle relative to the pivot mount 4.

The device 1 further includes a releasable locking means comprising interlocking components on the longitudinal body and handle. As best seen in FIGS. 1 and 2, a section 9 of the longitudinal body includes a locking block 10 for receiving a locking pin 21. In this embodiment, the locking pin 11 is spring loaded (not shown) so that the locking pin is biased towards a locking condition where it extends from the locking block across the cut-out portion 5 of the mounting portion. The base portion of the handle includes an opening (not shown) for receiving the locking pin 21. As the handle is moved between a folded condition (FIG. 1) towards an operating condition (FIG. 2), the base portion of the handle urges against the locking pin 21 until the locking pin 21 is received in the opening of the base portion. The locking pin 21 locates the handle within the cut-out portion so as to orient the handle perpendicular to the body. In order to move from an operating condition to a fold-down condition (FIG. 1), the locking pin 21 is retracted within the locking block 10

In the embodiments shown, various faces of the longitudinal body 2 include plumb indicators 11 and level indicators 12. The longitudinal body 2 also includes spaced-apart gripping recesses 13 and 14.

In an operating condition as shown in FIGS. 2 and 3, the handle 3 or second member is gripped by an operator and allows an operator to guide the longitudinal body 2 substantially at right angles to the handle into a position to measure a predetermined distance and level of a surface (not shown). Once this surface has been assessed, the operator can easily reposition the longitudinal body along a further section of a surface such as a floor, walls, or ceilings of a building structure substantially without having to kneel, bend, or requiring a ladder.

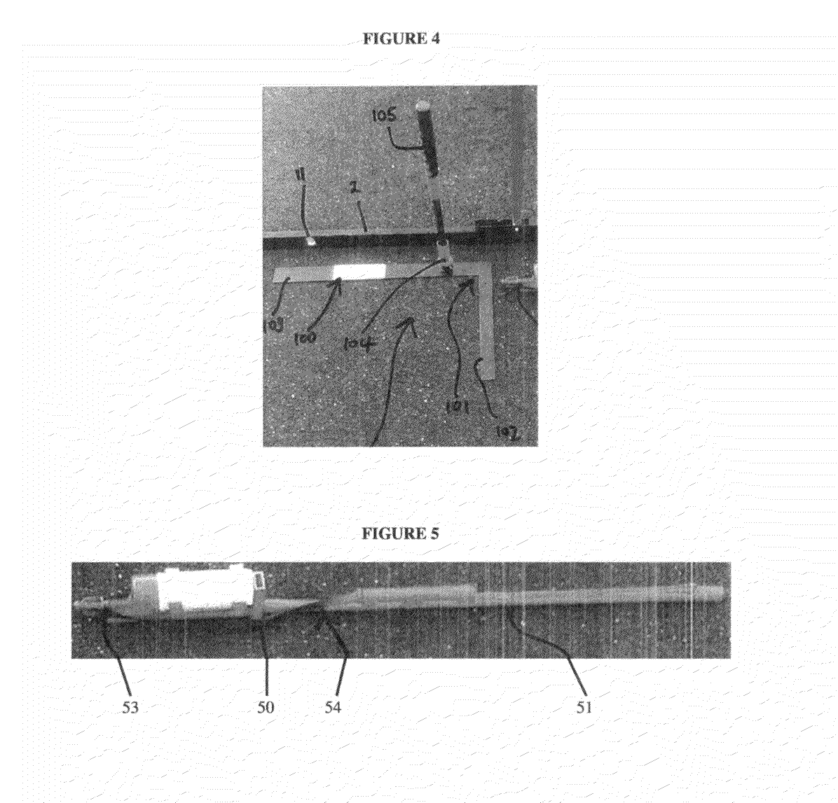

Referring to FIG. 4, there is shown a square measuring device 100 formed of a planar member 101 including a first longitudinal member 102 and a second longitudinal member 103 attached to one end of the first member and extending perpendicular thereto. In the embodiment shown, the second member 103 includes a mounting portion 104 which includes a tubular body with an open end, and a handle 105 received in the open end of the mounting portion 104. In the embodiment shown, the handle 105 projects upwardly from the mounting portion substantially at right angles to the plane of the planar member 101 so that the handle can be used by an operator to direct the planar member over a surface to measure squareness of the surface. In a further embodiment (not shown), the device 100 can be attachably mounted to a portion of the device 1.

Referring to FIG. 5, there is shown a marker device 50 adapted to be mounted on a portion of the longitudinal body 2 of the squareness measuring device 1. In this embodiment, the marker device includes a support pole 51 mountable to the longitudinal body 2, a mounting structure 52 for receiving a canister of paint or other marking fluid, wherein the mounting structure further includes a trigger mechanism 53 which initiates release of marking fluid from the canister. The trigger mechanism is attached to a cord or like means 54, which can be pulled by an operator to actuate the trigger mechanism when the indicators on the square measuring device 1 indicate off-square.

In the normal course of measuring square of a floor, walls, and ceilings of a building structure, the trigger device is actuated by an operator by pulling on the cord when the square measuring device identifies areas of a surface which are not square. Alternatively (not shown), the trigger device 50 can be linked directly to the indicators to automatically activate egress of marking fluid from the canister when the indicators of the square measuring device depart from square.

While illustrative embodiments have been illustrated and described, it will be appreciated that various changes can be made therein without departing from the spirit and scope of the invention.

The embodiments of the invention in which an exclusive property or privilege is claimed are defined as follows:

1. A device for measuring ‘square’ of a building structure having walls, floors, and ceilings, wherein the device includes:
a substantially longitudinal planar body having a mounting portion for receiving a handle member, and one or more level indicators; and
a handle member wherein the handle member is adapted to be adjustably mounted on the mounting portion of the body to allow selective positioning of the handle member relative to the body,
wherein the mounting portion of the body includes a releasable locking means which locates the handle member substantially perpendicular to the body in an operating condition for performing square measurements of floors, walls, and ceilings of the building structure or the like, and in a released condition the locking means allows the handle member to fold against the body.

2. A device for measuring ‘square’ of a building structure having walls, floors and ceiling according to claim 1, in which one of the two members is provided with one or more bubble gauges, enabling the apparatus to be used as a builders' level.

3. A device for measuring squareness of floors, walls and ceilings of a building or like structure including:
a first elongate member having generally rectangular or square cross-section having a level indicator;
a second member adjustably mounted to the first elongate member wherein the second member is adjustably movable relative to the first elongate member between a storage and operating condition; and
a releasable locking means which operates to locate and hold the second member substantially perpendicular relative to the elongate member in an operating condition,
wherein in an operating condition, the second member guides the first member into a position to measure a predetermined distance and level of a surface, and whereby the second member can readily reposition the first member along a surface substantially without an operator kneeling, bending, or requiring a climbing device.

4. A device for measuring squareness of floors, walls, and ceilings of a building or like structure according to claim 3, further including a marker device adapted to be mounted on a portion of the longitudinal body of the squareness measuring device, the marker device including:
a support pole mountable to the longitudinal body; and
a mounting structure on the longitudinal body for receiving a canister of a marking fluid,
wherein the mounting structure further includes a trigger mechanism which initiates release of marking fluid from the canister when the indicators on the square measuring device indicates off-square.

5. A device for measuring squareness of floors, walls, and ceilings of a building or like structure according to claim 1, further including a marker device adapted to be mounted on a portion of the longitudinal body of the squareness measuring device, the marker device including:
a support pole mountable to the longitudinal body; and
a mounting structure on the longitudinal body for receiving a canister of a marking fluid,
wherein the mounting structure further includes a trigger mechanism which initiates release of marking fluid from the canister when the indicators on the square measuring device indicates off-square.
